(19) United States
(12) Patent Application Publication
(10) Pub. No.: US 2010/0236665 A1
(43) Pub. Date: Sep. 23, 2010

(54) Method of Processing Wooden Piece

(75) Inventor: Tatsuya SUZUKI, Setagaya-ku (JP)

Correspondence Address: Hogan Lovells US LLP, 1999 AVENUE OF THE STARS, SUITE 1400, LOS ANGELES, CA, 90067, US

(73) Assignee: OLYMPUS CORPORATION, Tokyo (JP)

(21) Appl. No.: 12/793,542

(22) Filed: Jun. 3, 2010

Related U.S. Application Data
(63) Continuation of application No. PCT/JP2008/072460, filed on Dec. 3, 2008.

(30) Foreign Application Priority Data
Dec. 4, 2007 (JP) 2007-313844

(51) Int. Cl. B27M 1/08; B27M 1/02

(52) U.S. Cl. 144/360; 144/380

(57) ABSTRACT

A method of processing a wooden piece includes making holes each having a bottom in a wooden piece; softening the wooden piece with the holes; and compressing the softened wooden piece to deform the wooden piece into a predetermined shape.

### CROSS-REFERENCE TO RELATED APPLICATIONS

This application is a continuation of PCT international application Ser. No. PCT/JP2008/072460 filed on Dec. 3, 2008 which designates the United States, incorporated herein by reference, and which claims the benefit of priority from Japanese Patent Applications No. 2007-313844, filed on Dec. 4, 2007, incorporated herein by reference.

### BACKGROUND OF THE INVENTION

1. Field of the Invention

The present invention relates to a method of processing a wooden piece into a three-dimensional shape through compression.

2. Description of the Related Art

In recent years, wooden materials that are natural materials attract attention. With a wide variety of grain patterns, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden materials: a wooden board is softened with water absorption and compressed; the compressed wooden board is cut along a direction substantially parallel with a direction in which the compressive force is applied, whereby a primary fixed product with a sheet-like shape is obtained; and the primary fixed product is deformed into a desired three-dimensional shape under heat and moisture (for example, see Japanese Patent No. 3078452 Publication). Further, according to another conventional technique, a softened wooden sheet is compressed and temporarily secured in a prepared mold and left in the mold until the wooden sheet recovers. Thus a wooden product with a desired shape can be obtained (see, for example, Japanese Patent Application Laid-Open No. H11-077619).

### SUMMARY OF THE INVENTION

A method of processing a wooden piece according to an aspect of the present invention includes making holes each having a bottom in a wooden piece; softening the wooden piece with the holes; and compressing the softened wooden piece to deform the wooden piece into a predetermined shape.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart showing an outline of a method of processing a wooden piece according to an embodiment of the present invention;

FIG. 2 shows an outline of a cutting-out process in the method of processing the wooden piece;

FIG. 3 shows an outline of a hole-making process in the method of processing the wooden piece;

FIG. 4 shows an outline of a compression process in the method of processing the wooden piece;

FIG. 5 is a cross-sectional view taken along A-A line of FIG. 4;

FIG. 6 is the wooden piece which has been substantially deformed in the compression process;

FIG. 7 is a partial cross-sectional view of a main plate portion of the compressed wooden piece;

FIG. 8 shows a configuration of an exterior for electronic equipment, formed by the method of processing the wooden piece;

FIG. 9 is a perspective view of a configuration of a digital camera which is housed in the exterior for electronic equipment;

FIG. 10 is a partial cross-sectional view of a wooden piece after the hole-making process of the method of processing the wooden piece (Second example);

FIG. 11 is a partial cross-sectional view of a wooden piece after the hole-making process of the method of processing the wooden piece (Third example);

FIG. 12 shows an example of a density distribution of holes arranged along the lengthwise direction of the wooden piece shown in FIG. 11;

FIG. 13 is a partial cross-sectional view of a configuration of the wooden piece shown in FIG. 11 after the hole-making process; and

FIG. 14 is a partial cross-sectional view of another configuration of the wooden piece shown in FIG. 11 after the hole-making process.

### DETAILED DESCRIPTION OF THE PREFERRED EMBODIMENTS

Preferred embodiments of the present invention (hereinafter simply referred to as embodiments) will be described below with reference to the accompanying drawings. The drawings referred to below include schematic diagrams and views; some objects can be presented in different dimension and scale over the drawings even if the objects are the same.

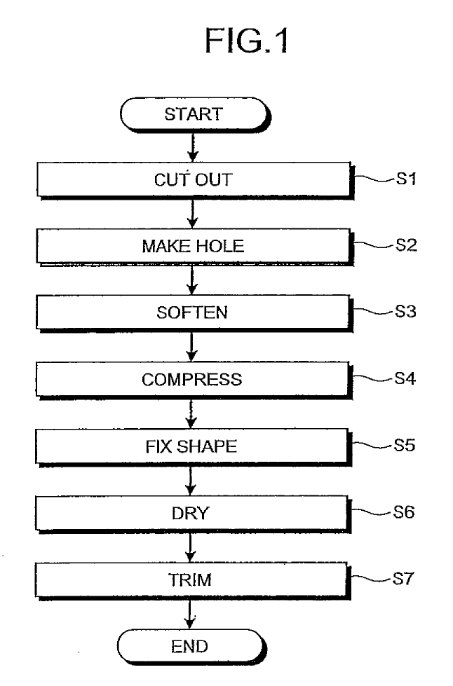

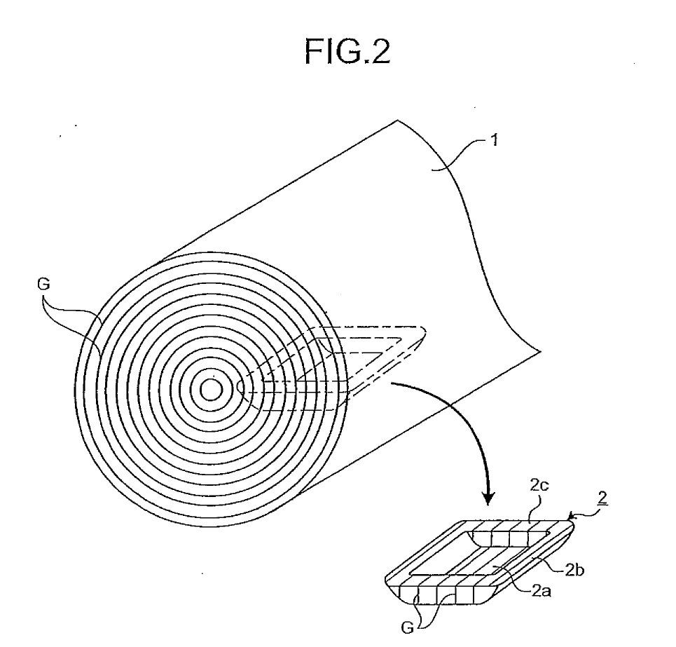

FIG. 1 is a flowchart showing an outline of a method of processing a wooden piece according to an embodiment of the present invention. A wooden piece 1 shown in FIG. 1 is cut out from uncompressed raw wood 10 by cutting or the like. Firstly, a wooden piece of a predetermined shape is cut out from raw wood (cutting-out process) before it is formed (Step S1). FIG. 2 schematically shows an outline of the cutting-out process. In the cutting-out process, a wooden piece 2 having a substantially dish-like shape is cut out from uncompressed raw wood 1 by cutting or the like. The raw wood 1 may be selected, for example, from various types of wood, such as, Japanese cypress, hiba cedar, paulownia, Japanese cedar, pine, cherry, zelkova, ebony wood, bamboo, teak, mahogany, and rosewood as appropriate depending on the use of the processed wooden piece.

The wooden piece 2 includes a substantially rectangular main plate portion 2a, two side plate portions 2b that curve and extend from two lengthwise sides of the main plate portion 2a, respectively, which are facing with each other on the surface of the main plate portion 2a, and two side plate portions 2c that are bent and extend from two breadthwise sides of the main plate portion 2a, respectively, which are facing with each other on the surface of the main plate portion 2a. The wooden piece 2 has a volume which is larger than a finished product by an amount to be decreased during compression process described later. The wooden piece 2 shown in FIG. 2 has a flat-grain pattern G, which is substantially parallel with the direction of the wooden fibers of the wooden piece 2, but it is one example. Alternatively, the wooden piece 2 may have a straight-grain pattern.

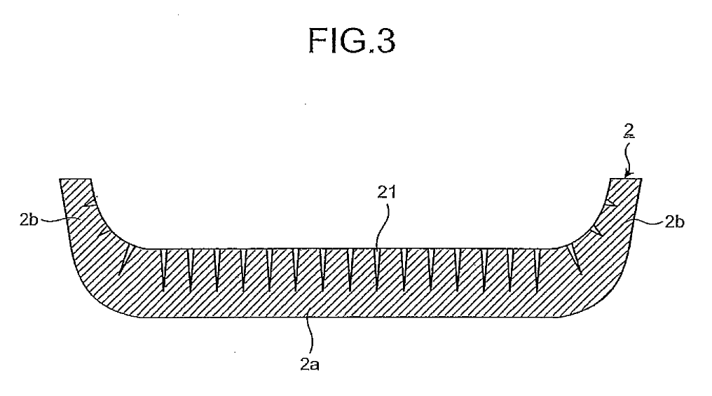

After Step 1, holes with bottoms are made in the wooden piece 2 (Step S2). FIG. 3 is a cross-sectional view of the wooden piece 2 with the holes made. In FIG. 3, a plurality of holes 21 are made so that their openings are arranged on the internal face of the dish-like wooden piece 2. Specifically, the holes having substantially the same depth are arranged over the main plate 2a of the wooden piece 2 at approximately equal intervals. Each of the side plate portions 2b has a thickness gradually decreased toward its end; the depth of the holes 21 is decreased depending on the thickness of the side plate portions 2b. At Step S2, the holes 21 can be made one by one with an awl or at a time with a jig having sharp tips regularly-arranged. The number of holes 21 and the diameter of the holes 21 can be determined based on the specifications of the wooden piece 2 such as material, shape, and size, approximately.

After Step S2, the wooden piece 2 is left in a water vapor atmosphere of a temperature and pressure higher than those of an atmospheric air for a predetermined time period, whereby the wooden piece 2 is softened through absorption of moisture in excess (Step S3). Here, the high temperature is about 100 to 230° C. and the high pressure is about 0.1 to 3.0 MPa (MegaPascal). Such a water vapor atmosphere can be provided by a pressure vessel. If the pressure vessel is used, the softening process is that the wooden piece 2 is left in the pressure vessel.

The wooden piece 2 has the plurality of holes 21 by the hole-making process. Accordingly, the wooden piece 2 allows water vapor to easily infiltrate inside through the holes 21. In other words, the wooden piece 2 absorbs water faster than a wooden piece without the holes 21. As a result, the holes 21 reduce a time required for softening the wooden piece 2, specifically up to such an extent that no damage occurs in the wooden piece 2 during the compression process described later.

The softening process at Step S3 may include heating the wooden piece 2 with high-frequency electromagnetic wave like microwave after the surface of the wooden piece 2 is exposed to water vapor, or boiling the wooden piece 2.

After Step S3, the softened wooden piece 2 is compressed (Step S4). At Step S4, the softened wooden piece 2 is deformed into a predetermined three-dimensional shape in such a manner that the wooden piece 2 is sandwiched by a pair of metal molds so as to be subjected to a compressive force in the water vapor atmosphere where the wooden piece 2 is softened. If the pressure vessel is used for the softening process, the wooden piece 2 may be subsequently compressed in the same pressure vessel.

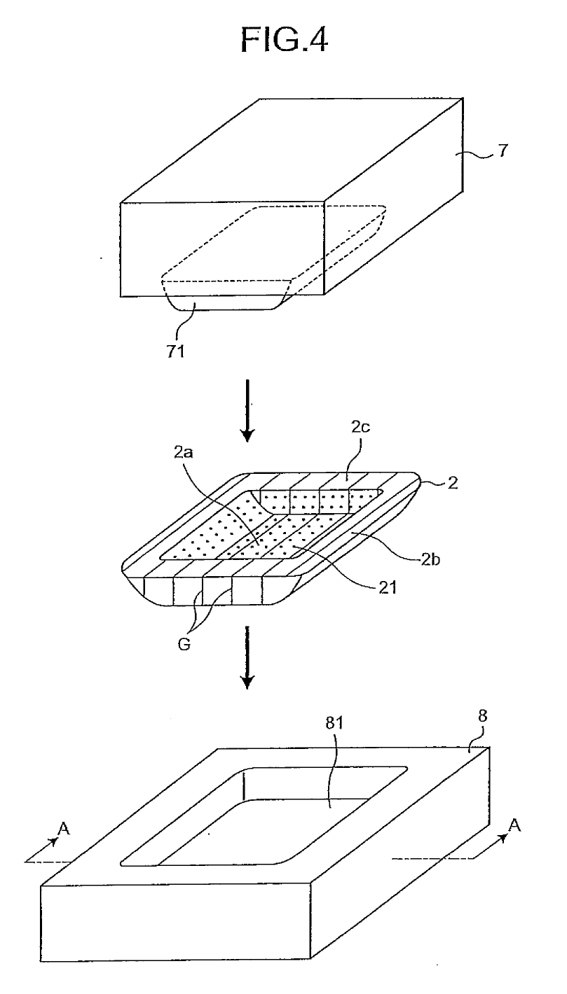

FIG. 4 shows an outline of the compression process and a configuration of the pair of metal molds used in the compression process in the method of processing the wooden piece. FIG. 5 is a cross-sectional view taken along A-A line of FIG. 4. As shown in FIGS. 4 and 5, the wooden piece 2 is sandwiched and compressed by a pair of metal molds 7 and 8.

Of the pair of metal molds, a metal mold 7 which applies compressive force to the wooden, piece 2 from above during compression is a core metal mold which has a protrusion 71 that fits to the internal face of the wooden piece 2 where the holes 21 are formed. When the radius of curvature of an internal face of a curved portion extending from the main plate portion 2a to the side plate portion 2b of the wooden piece 2 is represented as RI, and the radius of curvature of a curved surface of the protrusion 71, which abuts the curved portion, is represented as RA, relation represented by RI>RA holds.

On the other hand, a metal mold 8 which applies compressive force to the wooden piece 2 from below during compression is a cavity metal mold which has a depression 81 that fits to an external face of the wooden piece 2. When the radius of curvature of an external face of a curved portion extending from the main plate portion 2a to the side plate portion 2b of the wooden piece 2 is represented as RO, and the radius of curvature of a curved surface of the depression 81, which abuts the external face of the curved portion is represented as RB, relation represented by RO>RB holds.

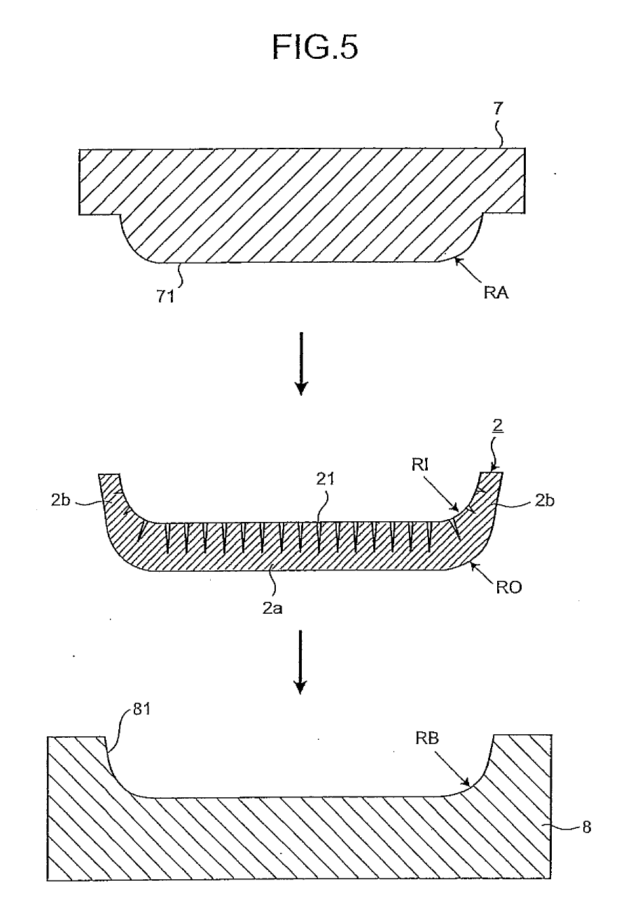

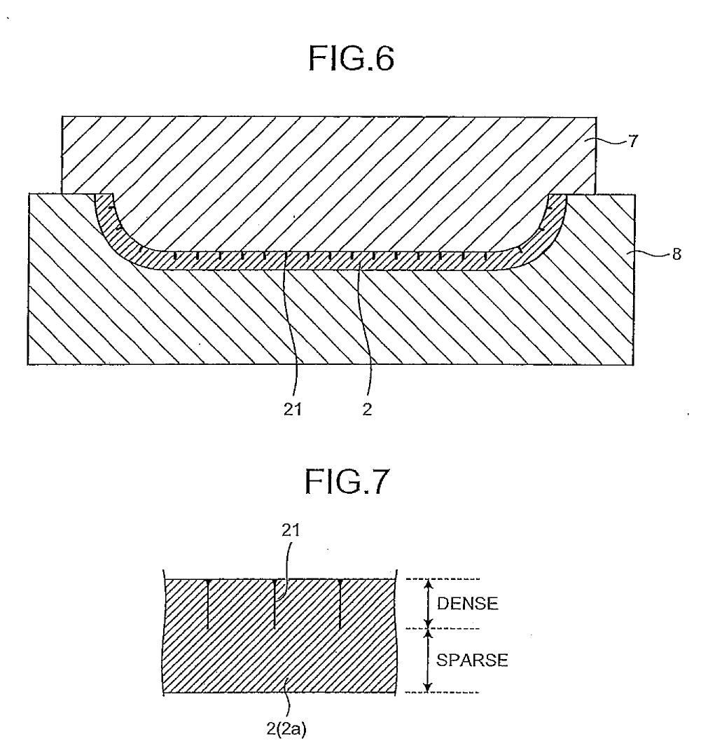

The metal molds 7 and 8 are clamped by a clamping jig after sandwiching the wooden piece 2. FIG. 6 shows a state where the clamped metal molds 7 and 8 apply compressive force to the wooden piece 2, and where the deformation of the wooden piece 2 has nearly completed. As shown in FIG. 6, the wooden piece 2 is deformed into a three-dimensional shape corresponding to the shape of a gap between the metal molds 7 and 8 by the application of compressive force from the metal molds 7 and 8.

After the wooden piece 2 is compressed for a predetermined time period (one to dozens of minutes, or more preferably approximately 5 to 10 minutes) in the state shown in FIG. 6, water vapor of a temperature higher than the water vapor used in the compression process is applied to the clamped metal molds 7 and 8 to fix the shape of the wooden piece 2 (Step S5). If the pressure vessel is used in the fixing process, water vapor of a temperature higher than the water vapor used in the compression process may be introduced into the pressure vessel.

After Step S6, the water vapor atmosphere is removed to dry the wooden piece 2 (Step S6). In order to facilitate drying of the wooden piece 2, the metal molds 7 and 8 may be separated from each other so that the wooden piece 2 is released from the clamping.

FIG. 7 is a partial cross-sectional view of the main plate portion 2a of the dried wooden piece 2. In FIG. 7, the holes 21 made in the wooden piece 2 are closed by the compression process with the metal molds 7 and 8. The portions where the holes are previously made are easily softened in the softening process, and thus have a compression rate (ΔR/R of a reduced amount of thickness ΔR of the wooden piece after the compression to the thickness R of the wooden piece before the compression) larger than that of portions where no holes are made. Accordingly, in the dried wooden piece 2, a density of the portions where the holes 21 are previously made is larger than a density of the portions where no holes are made. In other words, the portions where the holes 21 are previously made are harder than the portions where no holes are made.

The thickness of the dried wooden piece 2 is preferably about 30% to 50% of the wooden piece 2 before the compression. This means that the compression rate of the wooden piece 2 is about 0.50 to 0.70. As described above, the compression rate of the portions where the holes 21 are previously made is larger than that of the portions where no holes are made. In this view, the compression rate of about 0.50 to 0.70 indicates an average in the thickness direction of the wooden piece 2.

After dried, the wooden piece 2 is trimmed into a finished shape through a process such as cutting and punching (Step S7).

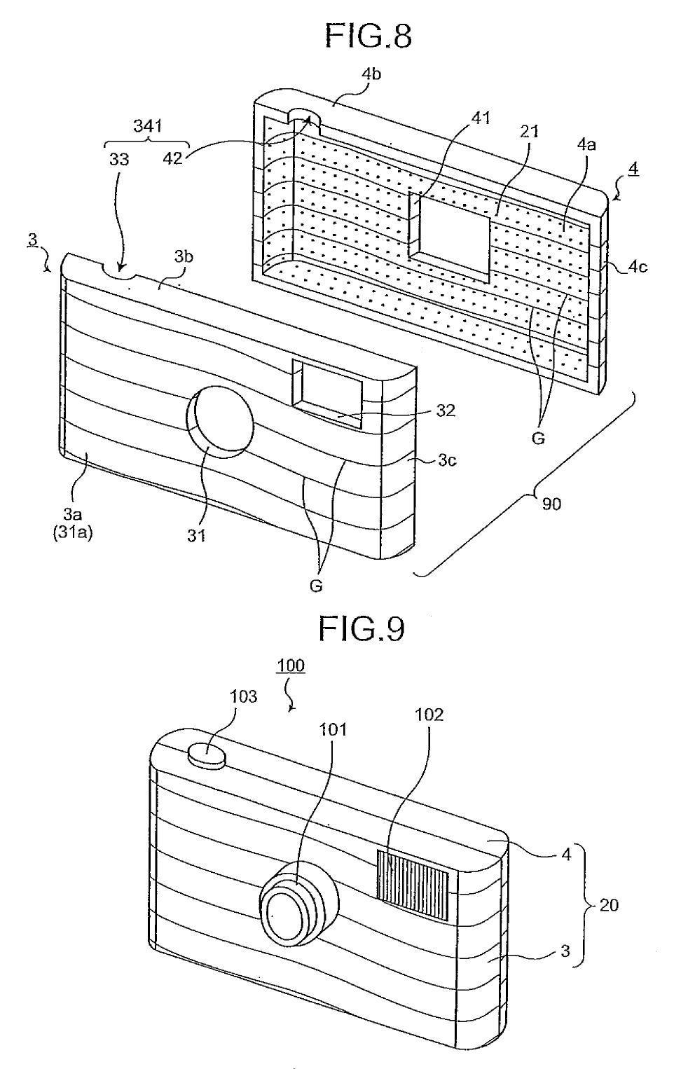

FIG. 8 shows a configuration of an exterior for electronic equipment, which is an example of a wooden piece formed by the method of processing the wooden piece described above. An exterior for electronic equipment 90 includes two cover members 3 and 4 which are combined with each other. The cover members 3 and 4 are formed from the wooden piece 2 and constitute a housing as a whole.

The exterior for electronic equipment 90 houses a digital camera 100 as shown in FIG. 9. The cover member 3, which covers the front side of the digital camera 100 (the side facing a subject), includes a main plate portion 3a, side plate portions 3b and 3c corresponding respectively to the main plate portion 2a, side plate portions 2b and 2c of the wooden piece 2. Referring to FIG. 9, the main plate portion 3a has a circular opening 31 through which an image pick-up unit 101 of the digital camera 100 is exposed and a rectangular opening 32 through which a photoflash 102 of the digital camera 100 is exposed. The side plate portion 3b has a semicircular notch 33.

The cover member 4, which covers the back side of the digital camera 100 (the side facing a user), includes a main plate portion 4a, side plate portions 4b and 4c corresponding respectively to the main plate portion 2a, side plate portions 2b and 2c of the wooden piece 2. The main plate portion 4a has a rectangular opening 41 through which a display of the digital camera 100, such as a liquid crystal display, a plasma display, an organic electro-luminescent display, is exposed. The side plate portion 4b has a semicircular notch 42. The notch 42 and the notch 33 form an opening 341 through which a shutter button 103 of the digital camera 100 is exposed.

In the cover members 3 and 4 formed from the wooden piece 2, the trace of the holes 21 having been closed by the compression is concealed inside after the digital camera 100 is assembled, and thus has no influence on the design of the digital camera 100.

The method of processing a wooden piece according to the embodiment is applicable to an exterior for electronic equipment other than digital cameras. For example, the processed wooden piece for an exterior for portable electronic equipment preferably has a thickness of 1.6 to 2.0 mm.

The method of processing a wooden piece according to the embodiment is also applicable to dishes, a variety of housings, and building materials.

According to the embodiment described above, holes made in a wooden piece before the wooden piece is softened allow the wooden piece to easily absorb water vapor in water vapor atmosphere in the softening process. Accordingly, it is possible to reduce a time required for softening the wooden piece before the compression.

According to the embodiment, the portions where the holes are made are different in density from the portions where no holes are made. In the conventional method of processing a wooden piece through compression, the density of the compressed wooden piece generally does not depend on position. On the contrary, the method according to the embodiment allows the wooden piece to have portions of different density (see FIG. 7).

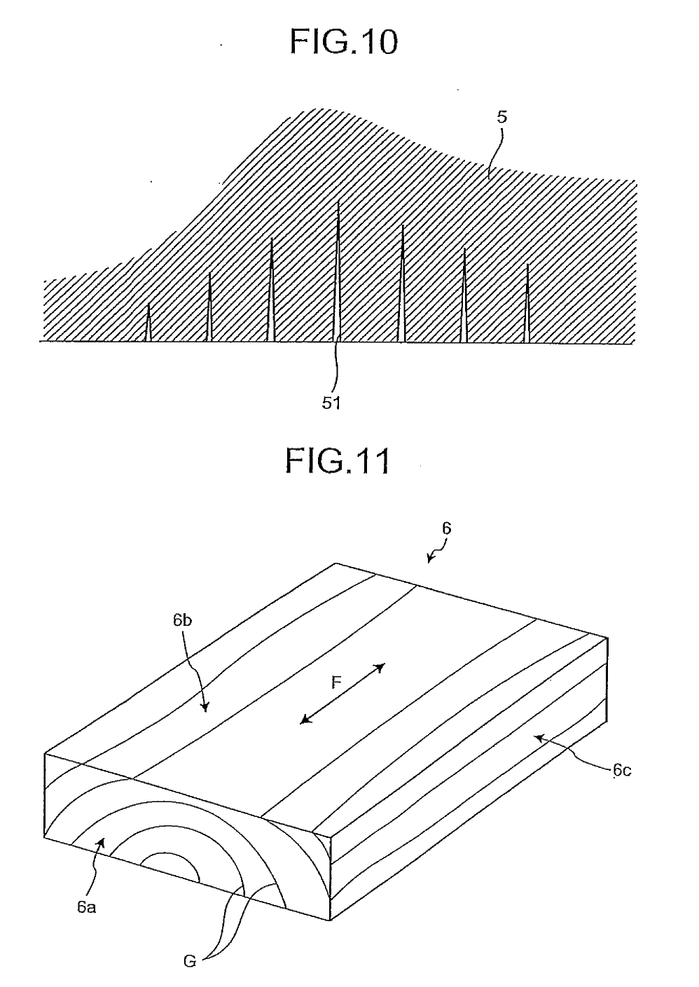

The method of processing a wooden piece according to the embodiment is applicable independently of the shape of a wooden piece to be cut out. For example, the method is applicable to a wooden piece having thicknesses in a large range as a wooden piece 5 shown in FIG. 10 (Second example). In this example, if holes 51 are made in the wooden piece 5 so that their depths are approximately proportional to the thicknesses of the portion of the wooden piece 5 where holes are made, the wooden piece 5 can be uniformly softened independent of the thickness.

FIG. 11 is a partial cross-sectional view of another example of a wooden piece to which the method of processing a wooden piece according to the embodiment is applicable (Third example). A wooden piece 6 shown in FIG. 11 is plate-shaped, and the lengthwise direction is substantially parallel with a direction F of wooden fibers of the wooden piece 6. When this wooden piece 6 is formed, an end face 6a (perpendicular to the fiber direction F) where the vessel or tracheid of the wooden piece 6 is exposed absorbs water easier than straight-grain faces 6b and 6c (parallel to the fiber direction F). Consequently, when the wooden piece 6 just cut out as shown in FIG. 11 is exposed to water vapor, an absorbed amount of water in the wooden piece 6 depends on position. Accordingly, by making holes with bottoms extending in a direction perpendicular to the fiber direction F in the straight-grain faces 6b and 6c before the wooden piece 6 is softened, an absorbed amount of water from the straight-grain faces 6b and 6c may be increased up to an amount close to that from the end face 6a. The density distribution of holes made in the straight-grain faces 6b and 6c (the number of holes per unit area) can be determined based on the specifications of wooden piece 6 such as a ratio of a surface area of the end face 6a to a total of surface areas of the straight-grain faces 6b and 6c, or lengths of the straight-grain faces 6b and 6c in the lengthwise direction.

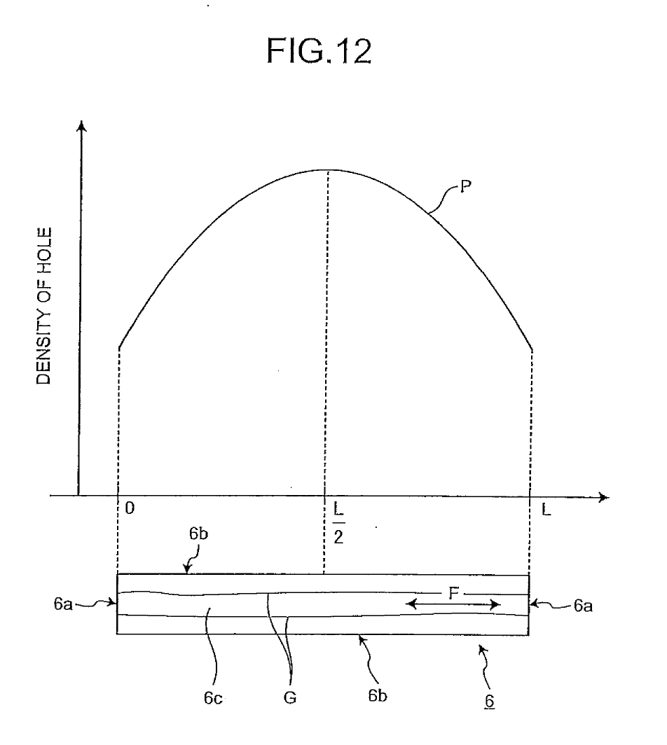

FIG. 12 shows an example of a density distribution of holes arranged along the lengthwise direction of the wooden piece 6. The density distribution curve P shown in FIG. 12 shows that the density of holes made in a central area in the lengthwise direction (length L) of the wooden piece 6 which is hard to absorb water is larger than that of holes made in the vicinity of an end in the lengthwise direction, i.e., the end face 6a. On the other hand, the density of holes made along the breadthwise direction of the straight-grain faces 6b and 6c is uniform. Making holes in the wooden piece 6 based on this density distribution curve P suppresses the position dependence of absorbed amount of water, especially along the lengthwise direction, when the wooden piece 6 is softened, and it is possible to soften the wooden piece 6 uniformly.

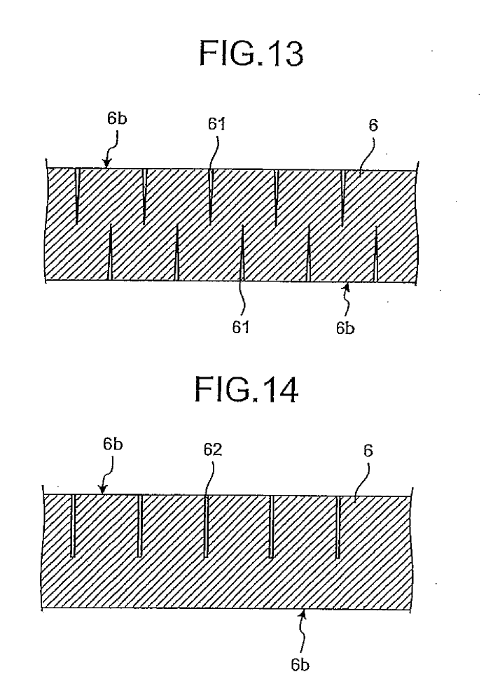

FIG. 13 is a partial cross-sectional view of the wooden piece 6 after the hole-making process. As shown in FIG. 13, a plurality of holes 61 each having a sharp tip are formed in the both straight-grain faces 6b regularly based on the density distribution curve P. The holes 61 can also be formed in the both straight-grain faces 6c as the holes 61 for the both straight-grain faces 6b.

Holes 62 having equal diameters may be made in one of the straight-grain faces 6b as shown in FIG. 14. The holes 62 are made with, for example, a small diameter drill.

The preferred embodiments of the present invention are described above, but not limited to the invention. For example, the cross section of the holes made in the wooden piece may have a shape other than that described above.

Moreover, after holes are made in a log-like wooden piece cut out from raw wood, the log-like wooden piece may be softened and compressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of processing a wooden piece, comprising:
making holes each having a bottom in a wooden piece;
softening the wooden piece with the holes; and
compressing the softened wooden piece to deform the wooden piece into a predetermined shape.

2. The method according to claim 1, wherein
each of the holes has a depth determined based on a thickness of a portion of the wooden piece where the hole is made.

3. The method according to claim 1, wherein
the holes are made so as to extend in a direction substantially perpendicular to a fiber direction of the wooden piece.

4. The method according to claim 1, wherein
a lengthwise direction of the wooden piece is substantially parallel to a fiber direction of the wooden piece, and
the holes are made so that the number of holes per unit area arranged in a central area in a lengthwise direction of the wooden piece is larger than the number of holes per unit area arranged in both end areas in the lengthwise direction.

5. The method according to claim 1, wherein the softening is performed under a water vapor atmosphere of a temperature and pressure higher than those of an atmospheric air.
